(19) United States
(12) Patent Application Publication
(10) Pub. No.: US 2015/0009202 A1
(43) Pub. Date: Jan. 8, 2015

(54) DISPLAY DRIVING CIRCUIT AND DISPLAY DEVICE

(71) Applicant: SILICON WORKS CO., LTD., Daejeon-si (KR)

(72) Inventors: Hyun Ho CHO, Incheon-si (KR); Joon Ho NA, Daejeon-si (KR); Hyun Kyu JEON, Daejeon-si (KR); Yong Icc JUNG, Bucheon-si (KR)

(21) Appl. No.: 14/326,441

(22) Filed: Jul. 8, 2014

(30) Foreign Application Priority Data
Jul. 8, 2013 (KR) 10-2013-0079559

(51) Int. Cl. G09G 3/36

(52) U.S. Cl. CPC G09G 3/3696
USPC 345/212

(57) ABSTRACT

Disclosed is a display driving circuit including an output buffer unit that is connected to a common voltage and first and second voltages and outputs a pair of pixel signals; an output switch that directly connects the pair of pixel signals to a pair of output lines or connects the pair of pixel signals to the pair of output lines such that they cross each other; and a pre-charging unit that charges the pair of output lines by using pre-charging voltages. Consequently, power consumption and heat generation of the display driving circuit are reduced.

### BACKGROUND

1. Technical Field

The present disclosure relates to a display driving technology, and more particularly, to a display driving circuit for reducing power consumption and heat generation.

2. Related Art

A display driving circuit operates in an AC driving scheme in order to prevent image sticking that may occur when polarity material existing in a display panel is attached to an electrode. Furthermore, the display driving circuit uses an inversion (or polarity inversion) driving scheme in order to control a flicker phenomenon that occurs by parasitic capacitance of thin film transistors (TFTs) arranged in the display panel.

The conventional display driving circuit selectively supplies buffered pixel signals (or pixel driving signals) to output lines according to the inversion driving scheme. Furthermore, in order to reduce power consumption required for buffering pixel signals, the conventional display driving circuit may interconnect the output lines and pre-drive an output voltage to a common voltage Vcom during the time for which data signals, that is, pixel signals are not applied to the display panel.

FIG. 1 is a waveform diagram illustrating the output of the conventional display driving circuit.

Referring to FIG. 1, the conventional display driving circuit provides a display panel with an output voltage Vout that is changed according to the passage of time. The conventional display driving circuit may supply a pixel signal to the display panel in a panel charging/discharging period t1, and pre-drive the output voltage to a common voltage Vcom through a connection between output lines, that is, charge sharing in a pre-charge period t2.

The panel charging/discharging period t1 corresponds to a time range in which valid data, that is, the pixel signal is supplied to the display panel, and the pre-charging period t2 corresponds to a time range arbitrarily set such that charge is shared between the output lines before the pixel signal is supplied. The pixel signal corresponds to image data that is applied to the display panel and is actually realized.

The conventional display driving circuit provides the display panel with a pixel signal having a voltage that is changed from the common voltage Vcom, which is an intermediate point between a first polarity (+) and a second polarity (−), to the first polarity (+), or provides the display panel with a pixel signal having a voltage that is changed from the common voltage Vcom to the second polarity (−). Consequently, the conventional display driving circuit can reduce the amount of power consumption as compared with a technology for changing the voltage of a pixel signal from the first polarity (+) to the second polarity (−).

However, in the conventional display driving circuit, since a shift from the first polarity (+) to the common voltage Vcom occurs or a shift from the second polarity (−) to the common voltage Vcom occurs even in a period in which there is no polarity inversion, there is a problem that power may be unnecessarily consumed.

### SUMMARY

Various embodiments are directed to a display driving circuit capable of minimizing power consumption and heat generation.

Also, various embodiments are directed to a display driving circuit capable of reducing current consumption and heat generation in the polarity inversion and polarity non-inversion of a display panel.

Also, various embodiments are directed to a display driving circuit capable of allowing output terminals to efficiently share charge.

In an embodiment, a display driving circuit may include: an output buffer unit that outputs a pair of pixel signals by using a common voltage and first and second voltages; an output switch that directly transfers the pair of pixel signals to a pair of output lines or transfers the pair of pixel signals to the pair of output lines such that the pair of pixel signals cross each other in correspondence with repetitive panel charging/discharging periods; and a pre-charging unit that performs pre-charging for the pair of output lines in correspondence with a pre-charging period between the panel charging/discharging periods by using a first pre-charging voltage between the first voltage and the common voltage and a second pre-charging voltage between the second voltage and the common voltage.

In an embodiment, a display device may include: a display panel; and a display driving circuit that drives the display panel, wherein the display driving circuit may include: an output switch that directly transfers a pair of pixel signals to a pair of output lines or transfers the pair of pixel signals to the pair of output lines such that the pair of pixel signals cross each other in correspondence with repetitive panel charging/discharging periods; and a pre-charging unit that performs pre-charging for the pair of output lines in correspondence with a pre-charging period between the panel charging/discharging periods by using a first pre-charging voltage between a first voltage and a common voltage and a second pre-charging voltage between a second voltage and the common voltage.

In an embodiment, a display driving circuit may include: an output switch that directly transfers a pair of pixel signals with a positive polarity and a negative polarity to a pair of output lines or transfers the pair of pixel signals to the pair of output lines such that the pair of pixel signals cross each other in correspondence with repetitive panel charging/discharging periods; and a pre-charging unit that performs pre-charging for the pair of output lines in correspondence with a pre-charging period between the panel charging/discharging periods by using a first pre-charging voltage corresponding to the positive polarity and a second pre-charging voltage corresponding to negative polarity.

A display driving circuit according to an embodiment of the present invention can reduce current consumption and heat generation through a pre-charging unit.

The display driving circuit according to an embodiment of the present invention can reduce current consumption and heat generation in polarity inversion and polarity non-inversion through the pre-charging unit.

The display driving circuit according to an embodiment of the present invention can selectively control the operations of a pre-charging unit and a charge sharing switch, and allow output terminals to efficiently share charge.

### BRIEF DESCRIPTION OF THE DRAWINGS

FIG. 1 is a waveform diagram illustrating the output of a conventional display driving circuit.

FIG. 2 is a diagram illustrating a display driving circuit according to an embodiment of the present invention.

FIG. 3 is an exemplary diagram illustrating an embodiment of an output switch in FIG. 2.

FIG. 4 is an exemplary diagram illustrating an embodiment of a voltage generation circuit for generating a voltage applied to a pre-charging unit in FIG. 2.

FIG. 5 is a waveform diagram illustrating the output of a display driving circuit in FIG. 2.

FIG. 6 is another waveform diagram illustrating the output of a display driving circuit in FIG. 2.

FIG. 7a is a graph illustrating a simulation result of current consumption of a conventional display driving circuit and a display driving circuit in FIG. 2.

FIG. 7b is a graph illustrating a simulation result of heat generation of a conventional display driving circuit and a display driving circuit in FIG. 2.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

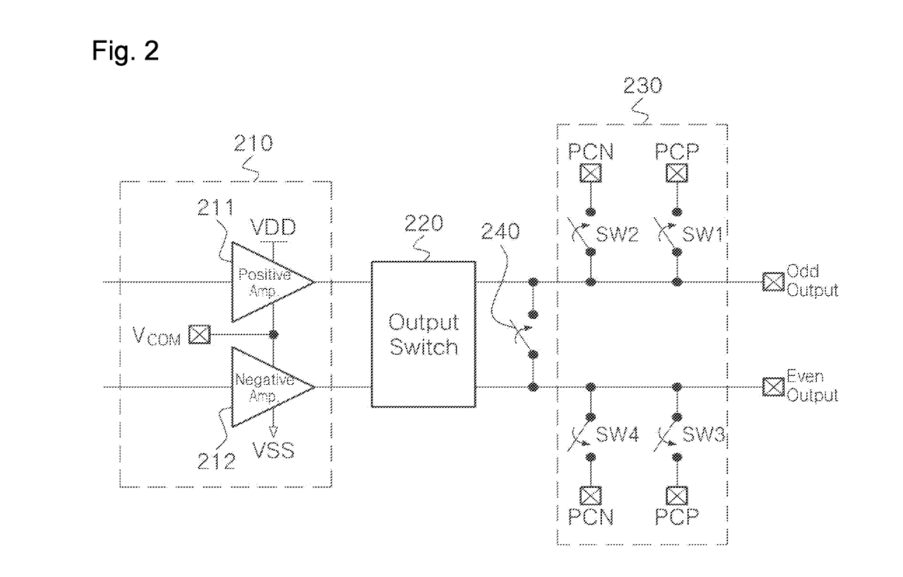

FIG. 2 is a diagram illustrating a display driving circuit according to an embodiment of the present invention.

Referring to FIG. 2, a display driving circuit 200 generates pixel signals and transfers the pixel signals to a display panel (not illustrated), and includes an output buffer unit 210, an output switch 220, and a pre-charging unit 230.

The output buffer unit 210 includes a pair of output buffers 211 and 212 that are connected to a common voltage Vcom and first and second voltages VDD and VSS, and buffer, or amplify and output a pair of pixel signals.

The first output buffer 211 is connected to the first voltage VDD and the common voltage Vcom, and operates in a first polarity (or a first voltage driving potential) region between the first voltage VDD and the common voltage Vcom. The first polarity may be expressed as a positive polarity. The second output buffer 212 is connected to the common voltage Vcom and the second voltage VSS, and operates in a second polarity (or a second voltage driving potential) region between the common voltage Vcom and the second voltage VSS. The second polarity may be expressed as a negative polarity. The first voltage VDD is higher than the second voltage VSS, and the common voltage Vcom is between the first and second voltages VDD and VSS. For example, the first and second voltages VDD and VSS and the common voltage Vcom may correspond to 10 V, 0 V, and 5 V, respectively.

The first and second output buffers 211 and 212 may be called a positive (+) buffer and a negative (−) buffer, respectively, and the first polarity may correspond to a voltage range higher than the second polarity.

In an embodiment, the common voltage Vcom may correspond to a voltage between the first and second voltages VDD and VSS, for example, an intermediate voltage. In more detail, the common voltage Vcom may be decided by an Equation of [(the first voltage VDD+the second voltage VSS)/2].

For example, the first and second voltages VDD and VSS correspond to 9 V and 0 V, respectively, the common voltage Vcom may correspond to 4.5 V (=(9+0)/2). As a consequence, the first and second polarities may be symmetrical to each other about the common voltage Vcom.

In an embodiment, each of the first and second output buffers 211 and 212 may be implemented with a unity gain buffer or an amplifier.

The output switch 220 may selectively connect the first output buffer 211 to a first output line (odd output) corresponding to an odd column of the display panel, or a second output line (even output) corresponding to an even column thereof. Simultaneously, the output switch 220 may selectively connect the second output buffer 212 to the second output line (even output) or the first output line (odd output).

The output switch 220 may transfer the output of the output buffer unit 210 to the display panel (not illustrated), and may correspond to a switching circuit for polarity inversion for preventing a sticking phenomenon of a display liquid crystal.

The output switch 220 includes at least one switch that is positioned between the output buffer unit 210 and the output lines (the odd output and the even output), is electrically connected to them, and may be selectively connected to the output lines (the odd output and the even output) according to a control signal.

The pre-charging unit 230 outputs a pair of buffered pixel signals by using pre-charging voltages between the first and second voltages VDD and VSS and the common voltage Vcom. In more detail, the pre-charging unit 230 pre-drive the pair of pixel signals to a corresponding pre-charging voltage by using the pre-charging voltages between the first voltage VDD and the common voltage Vcom and between the second voltage VSS and the common voltage Vcom, and outputs the pixel signals.

In an embodiment, the pre-charging unit 230 may include at least one first pre-charging voltage (PCP, a pre-charging positive voltage) between the first voltage VDD and the common voltage Vcom, and at least one second pre-charging voltage (PCN, a pre-charging negative voltage) between the common voltage Vcom and the second voltage VSS.

For example, when the first and second voltages VDD and VSS and the common voltage Vcom correspond to 10 V, 0 V, and 5 V, respectively, the first and second pre-charging voltages PCP and PCN may correspond to 7.5 V and 2.5 V, respectively.

Differently from this, the first pre-charging voltage PCP may correspond to 6 V, 7 V, 8 V, and 9 V, and the second pre-charging voltage PCN may correspond to 1 V, 2 V, 3 V, and 4 V. The first and second pre-charging voltages PCP and PCN may be expanded to two or more according to a product application example.

In an embodiment, the pre-charging unit 230 may include pre-charging switches SW1 to SW4 that connect the first and second pre-charging voltages PCP and PCN to the pair of output lines (the odd output and the even output).

In more detail, the pre-charging unit 230 may include a first pre-charging switch SW1 that connects the first pre-charging voltage PCP to the first output line (the odd output), a second pre-charging switch SW2 that connects the second pre-charging voltage PCN to the first output line (the odd output), a third pre-charging switch SW3 that connects the first pre-charging voltage PCP to the second output line (the even output), and a fourth pre-charging switch SW4 that connects the second pre-charging voltage PCN to the second output line (the even output).

The first and fourth pre-charging switches SW1 and SW4 operate together with each other under the control of a control unit (not illustrated), and the second and third pre-charging switches SW2 and SW3 operate together with each other under the control of the control unit (not illustrated). The operation indicates turning on or turning off.

In an embodiment, the pre-charging unit 230 may operate in pre-charging periods tpc1 to tpc3, may not operate in panel charging/discharging periods tcd1 to tcd4, may connect the output lines (the odd output and the even output) to pre-charging voltages with the same polarity when there is no change in the polarities of the output lines (the odd output and the even output) in the pre-charging periods, and may connect the output lines (the odd output and the even output) to pre-charging voltages with opposite polarities when there is a change in the polarities of the output lines (the odd output and the even output) in the pre-charging periods.

In more detail, the pre-charging unit 230 maintains a non-operation state in the panel charging/discharging periods under the control of the control unit (not illustrated), and operates when there is a change to the pre-charging periods. For example, when the voltages of the first and second output lines (the odd output and the even output) correspond to 9 V and 1 V in the first panel charging/discharging period, the polarities of the output lines (the odd output and the even output) may be determined to be first and second polarities, respectively. When the voltages of the first and second output lines (the odd output and the even output) correspond to 8 V and 2 V in the second panel charging/discharging period, the polarities of the output lines (the odd output and the even output) may be determined to be the first and second polarities, respectively. In this case, it may be determined that there is no change in the polarities of the output lines (the odd output and the even output).

At this time, in the first pre-charging period existing between the first and second panel charging/discharging periods, the pre-charging unit 230 may connect the first output line to the first pre-charging voltage PCP corresponding to 7.5 V and connect the second output line to the second pre-charging voltage PCN corresponding to 2.5 V. In other words, the pre-charging unit 230 may pre-drive the first and second output lines (the odd output and the even output) to the first and second pre-charging voltages PCP and PCN.

Differently from this, when the voltages of the first and second output lines (the odd output and the even output) are changed to 2 V and 8 V in the second panel charging/discharging period, the polarities of the output lines (the odd output and the even output) may be determined to be the first and second polarities, respectively. As a consequence, it may be determined that there is a change in the polarities of the output lines (the odd output and the even output).

At this time, in the first pre-charging period existing between the first and second panel charging/discharging periods, the pre-charging unit 230 may connect the first output line to the second pre-charging voltage PCN corresponding to 2.5 V and connect the second output line to the first pre-charging voltage PCP corresponding to 7.5 V. In other words, the pre-charging unit 230 may pre-drive the first and second output lines (the odd output and the even output) to the second and first pre-charging voltages PCN and PCP.

Consequently, a voltage 3 V (=8 V−5 V) to be supplied through the output buffer unit 210 can be lowered to 0.5 V (=8 V−7.5 V) by the pre-charging unit 230. As a consequence, power consumption through the output buffer unit 210 of the display driving circuit 200 can be reduced.

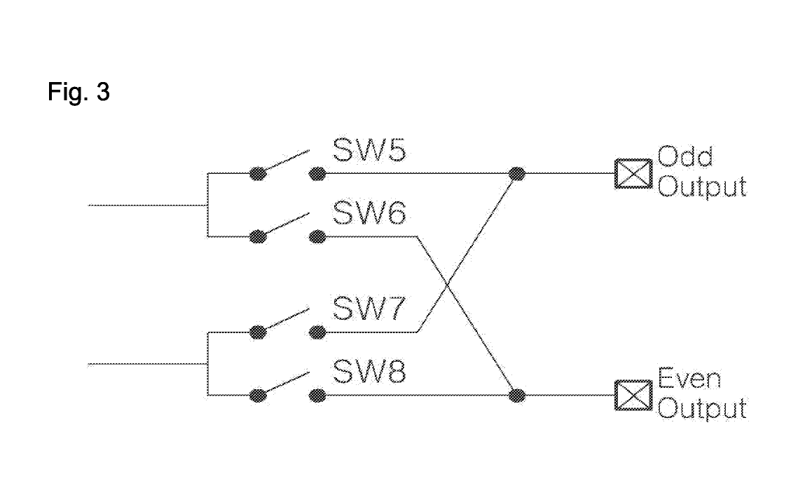

FIG. 3 is an exemplary diagram illustrating an embodiment of the output switch in FIG. 2.

Referring to FIG. 2 and FIG. 3, the output switch 220 may include a first switch SW5 connected to the first output buffer 211 and the first output line (the odd output), a second switch SW6 connected to the first output buffer 211 and the second output line (the even output), a third switch SW7 connected to the second output buffer 212 and the first output line (the odd output), and a fourth switch SW8 connected to the second output buffer 212 and the second output line (the even output).

In an embodiment, the output switch 220 may operate (On) in the first panel charging/discharging period tcd1, may not operate (Off) in the pre-charging period tpc1, may directly connect the pair of output buffers 211 and 212 to the output lines (the odd output and the even output) when the potential polarities of the output lines (the odd output and the even output) are equal to each other (hereinafter, referred to as “polarity non-inversion”) in the second panel charging/discharging period tcd2, and may connect the pair of output buffers 211 and 212 to the output lines (the odd output and the even output) such that they cross each other when the potential polarities of the output lines (the odd output and the even output) are changed (hereinafter, referred to as “polarity inversion”) in the second panel charging/discharging period tcd2.

In other words, the output switch 220 may operate according to a control signal output from the control unit (not illustrated). In more detail, the output switch 220 may operate in the following three types according to the control signal.

First, in a pixel signal transmission period, that is, a charging or discharging period of the display panel (hereinafter, referred to the “panel charging/discharging period” tcd1), the output switch 220 receives a first control signal from the control unit (not illustrated), and turns on the first switch SW5 such that the first output buffer 211 is connected to the first output line (the odd output), thereby allowing a pixel signal to be transmitted to a corresponding pixel through the first output line (the odd output). Simultaneously, the output switch 220 turns on the fourth switch SW8 such that the second output buffer 212 is connected to the second output line (the even output).

Second, in the panel charging/discharging period tcd2 and the polarity inversion period, the output switch 220 receives a second control signal from the control unit (not illustrated), and turns on the second switch SW6 such that the first output buffer 211 is connected to the second output line (the even output), and turns on the third switch SW7 such that the second output buffer 212 is connected to the first output line (the odd output).

Third, in the pre-charging period tpc1, the output switch 220 receives a third control signal from the control unit (not illustrated), and turns off all the first to fourth switches SW5 to SW8, thereby cutting data flows to the output lines (the odd output and the even output).

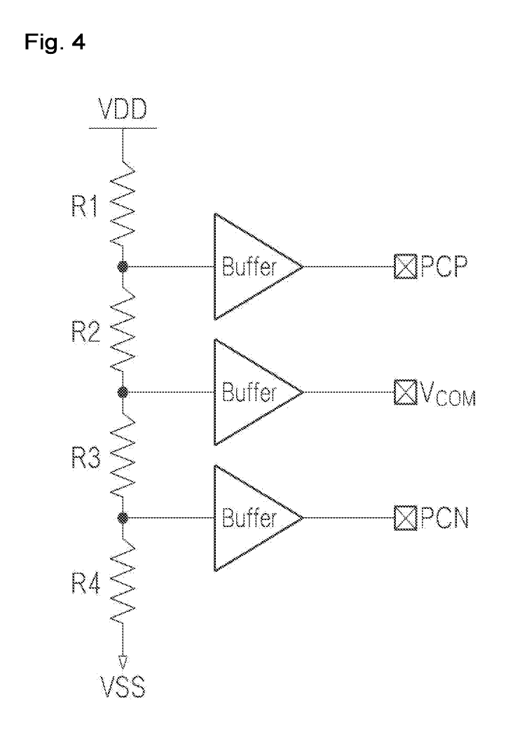

FIG. 4 is an exemplary diagram illustrating an embodiment of a voltage generation circuit for generating a voltage applied to the pre-charging unit in FIG. 2.

Referring to FIG. 4, the voltage generation circuit may include four resistors R1 to R4 that are serially connected to the first and second voltages VDD and VSS. The first and second voltages VDD and VSS may correspond to the same voltages connected to the output buffer unit 210. If necessary, the four resistors R1 to R4 may have the same resistance value.

The first pre-charging voltage PCP may be supplied from a node to which the first resistor R1 and the second resistor R2 are connected, and the second pre-charging voltage PCN may be supplied from a node to which the third resistor R3 and the fourth resistor R4 are connected.

The first and second pre-charging voltages PCP and PCN may be adjusted according to a change in the resistance values of the resistors.

In an embodiment, the voltage generation circuit may further include buffers connected to output terminals of the first and second pre-charging voltages PCP and PCN. Consequently, the voltage generation circuit can prevent a voltage drop of the first and second pre-charging voltages PCP and PCN.

The common voltage Vcom may be supplied from a node to which the second resistor R2 and the third resistor R3 are connected, and may also be supplied through a buffer.

In an embodiment, the first and second pre-charging voltages PCP and PCN may be supplied from an interior of the display driving circuit 200. For example, the voltage generation circuit may be implemented in the display driving circuit.

In an embodiment, the first and second pre-charging voltages PCP and PCN may be supplied from an exterior. For example, the first and second pre-charging voltages PCP and PCN may be supplied from a power supply unit outside of the display driving circuit.

In an embodiment, the display driving circuit may further include a charge sharing switch 240 that connects the pair of output lines to each other.

The charge sharing switch 240 may connect the pair of output lines to each other in the pre-charging period, and share charge that is discharged in a display process.

In more detail, the charge sharing switch 240 may include at least one charge sharing switch to connect or disconnect the first and second output lines (the odd output and the even output) to/from each other.

The charge sharing switch 240 connects the first and second output lines (the odd output and the even output) to each other in the pre-charging period, and disconnects the first and second output lines (the odd output and the even output) from each other in the panel charging/discharging period.

At this time, the pair of output lines (the odd output and the even output) can share charge according to the operation of the charge sharing switch 240, so that power consumption of the display driving circuit can be reduced.

In the pre-charging period, the switch in the charge sharing switch 240 is turned on, and the output lines (the odd output and the even output) are connected, so that the output lines share charge discharged from the display panel through the charge sharing switch 240, and maintains the same potential.

In the panel charging/discharging period, the switch in the charge sharing switch 240 is turned off, and charge sharing between the output lines (the odd output and the even output) is ended, so that charge transfer between the output lines is prohibited.

The display driving circuit may selectively operate the pre-charging unit 230 and the charge sharing switch 240.

In more detail, the display driving circuit may selectively operate the pre-charging unit 230 and the charge sharing switch 240 based on power consumption.

For example, when power consumption of a specific period is higher than an average (when average power consumption corresponds to 60 mW and the power consumption of the specific period corresponds to 90 mW), the display driving circuit may determine a white screen (when the difference between the potential of a pixel signal and the common voltage Vcom is relatively large), and operate only the pre-charging unit 230. However, when the power consumption is lower than the average (when the average power consumption corresponds to 60 mW and the power consumption of the specific period corresponds to 30 mW), the display driving circuit may determine a black screen (when the difference between the potential of a pixel signal and the common voltage Vcom is relatively small), and operate only the charge sharing switch 240.

In an embodiment, the display driving circuit may operate the charge sharing switch 240 when there is a change in the polarities of the output lines (the odd output and the even output) in the pre-charging period, and operate the pre-charging unit 230 when there is no change in the polarities of the output lines (the odd output and the even output) in the pre-charging period.

In the panel charging/discharging period, the display driving circuit 200 does not operate the pre-charging unit 230 and the charge sharing switch 240.

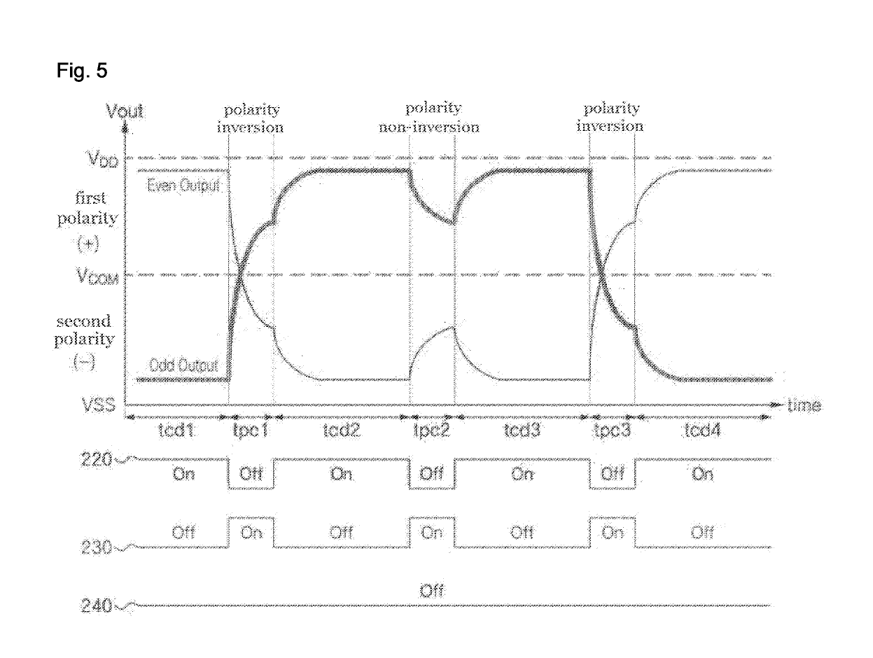

FIG. 5 is a waveform diagram illustrating the output of the display driving circuit in FIG. 2.

Referring to FIG. 5, the display driving circuit provides the display panel with a pixel signal that is changed according to the passage of time, that is, an output voltage Vout.

In the first panel charging/discharging period tcd1, the output switch 220 operates under the control of the control unit (not illustrated), and supplies the output lines with pixel signals that are output from the output buffer unit 210. In more detail, the output switch 220 connects buffered pixel signals to the pair of output lines such that they cross each other. At this time, the pre-charging unit 230 and the charge sharing switch 240 do not operate.

When the first panel charging/discharging period tcd1 is changed to the first pre-charging period tpc1, the output switch 220 does not operate under the control of the control unit (not illustrated), and the pixel signals output from the output buffer unit 210 may not be transferred to the display panel (not illustrated). The first pre-charging period tpc1 corresponds to a pre-charging period in which the polarities of the output lines are changed. The pre-charging unit 230 may turn on the first and fourth pre-charging switches SW1 and SW4 according to the polarity inversion of the output lines, thereby pre-driving the first output line (the odd output) to the first pre-charging voltage PCP and pre-driving the second output line (the even output) to the second pre-charging voltage PCN.

When the first pre-charging period tpc1 is changed to the second panel charging/discharging period tcd2, the output switch 220 operates under the control of the control unit (not illustrated) and directly connects the pixel signals output from the output buffer unit 210 to the output lines (the odd output and the even output) as described above. Similarly, the pre-charging unit 230 and the charge sharing switch 240 do not operate.

When the second panel charging/discharging period tcd2 is changed to the second pre-charging period tpc2, the output switch 220 does not operate under the control of the control unit (not illustrated), and the pixel signals output from the output buffer unit 210 may not be transferred to the display panel (not illustrated). The second pre-charging period tpc2 corresponds to a pre-charging period in which the polarities of the output lines are not changed (non-inversion). Simultaneously, the pre-charging unit 230 may turn on the first and fourth pre-charging switches SW1 and SW4, which have operated in the first pre-charging period tpc1, according to the polarity non-inversion of the output lines, thereby pre-driving the first and second output lines (the odd output and the even output) to the first and second pre-charging voltages PCP and PCN.

When the second pre-charging period tpc2 is changed to the third panel charging/discharging period tcd3, the output switch 220 operates and directly connects the buffered pixel signals to the pair of output lines (the odd output and the even output). At this time, the pre-charging unit 230 and the charge sharing switch 240 operate similarly to the first panel charging/discharging period tcd1.

When the third panel charging/discharging period tcd3 is changed to the third pre-charging period tpc3, the output switch 220 does not operate under the control of the control unit (not illustrated), turn on the second and third pre-charging switches SW2 and SW3, which have not operated in the second pre-charging period tpc2, according to the polarity inversion of the output lines, thereby pre-driving the first and second output lines (the odd output and the even output) to the second and first pre-charging voltages PCN and PCP. The third pre-charging period tpc3 corresponds to a pre-charging period in which the polarities of the output lines are changed.

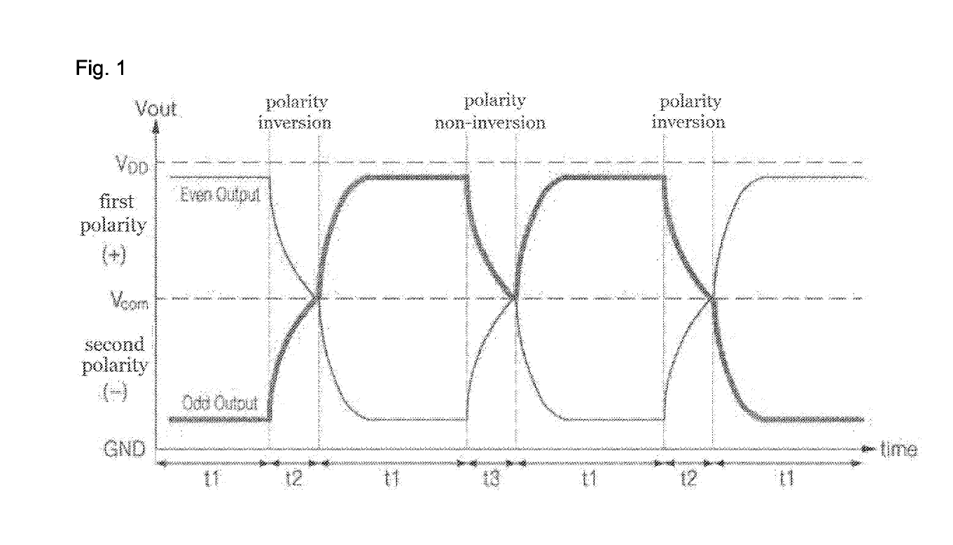

Consequently, a variation in the output potential of the pair of output lines (the odd output and the even output) in the panel charging/discharging periods can be reduced as compared with the potential variation described in FIG. 1, so that the consumption of power to be supplied from the output buffer unit 210 can be reduced.

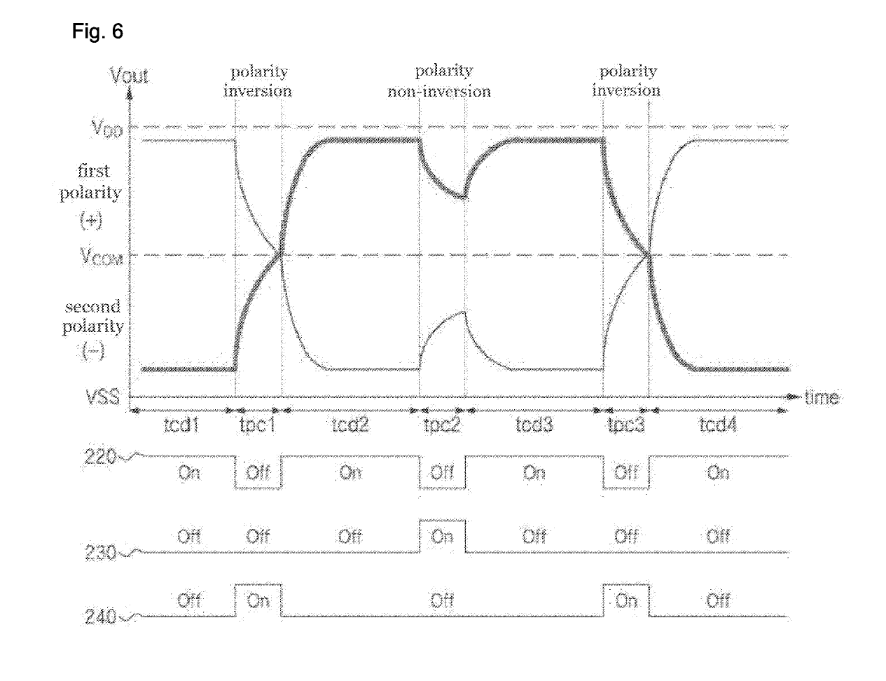

FIG. 6 is another exemplary diagram illustrating the output of the display driving circuit in FIG. 2.

Referring to FIG. 6, the display driving circuit selectively operates the pre-charging unit 230 and the charge sharing switch 240.

In more detail, the display driving circuit operates the charge sharing switch 240 when the polarities of the output lines (the odd output and the even output) are changed in the pre-charging period (t2), and operates the pre-charging unit 230 when the polarities of the output lines (the odd output and the even output) are not changed in the pre-charging period (tpc2).

In the first panel charging/discharging period tcd1, the display driving circuit operates similarly to the first panel charging/discharging period tcd1. Since the operations of the display driving circuit in the second and third panel charging/discharging periods tcd2 and tcd3 are equal to those in the corresponding periods tcd2 and tcd3 described in FIG. 5, a detailed description thereof will be omitted.

When the first panel charging/discharging period tcd1 is changed to the first pre-charging period tpc1 in which there is polarity inversion, the output switch 220 does not operate under the control of the control unit (not illustrated), and the charge sharing switch 240 operates, so that the pair of output lines (the odd output and the even output) may share charge that exists in the display panel and is to be discharged. As a consequence, the output potentials of the pair of output lines (the odd output and the even output) may be pre-driven to a common voltage.

At this time, the pre-charging unit 230 maintains a non-operation state.

When the second panel charging/discharging period tcd2 is changed to the second pre-charging period tpc2 in which there is no polarity inversion (polarity non-inversion), the output switch 220 does not operate under the control of the control unit (not illustrated), and the pre-charging unit 230 turns on the first and fourth pre-charging switches SW1 and SW4, which have operated in the first pre-charging period tpc1, according to the polarity non-inversion of the output lines, thereby pre-driving the first and second output lines (the odd output and the even output) to the first and second pre-charging voltages PCP and PCN. At this time, the charge sharing switch 240 maintains a non-operation state.

When the third panel charging/discharging period tcd3 is changed to the third pre-charging period tpc3 in which there is polarity inversion, the output switch 220 does not operate under the control of the control unit (not illustrated), and the charge sharing switch 240 operates, thereby connecting the pair of output lines (the odd output and the even output) to each other and pre-driving the pair of output lines (the odd output and the even output) to the common voltage Vcom. At this time, the pre-charging unit 230 maintains a non-operation state.

Consequently, in the pre-charging periods in which there is polarity inversion, power consumption is reduced using charge discharged from the display panel (not illustrated) through the charge sharing switch, and in the pre-charging periods in which there is no polarity inversion, a variation in the output potentials of the pair of output lines (the odd output and the even output) is reduced as compared with the potential variation described in FIG. 1, so that it is possible to reduce the consumption of power to be supplied from the output buffer unit 210.

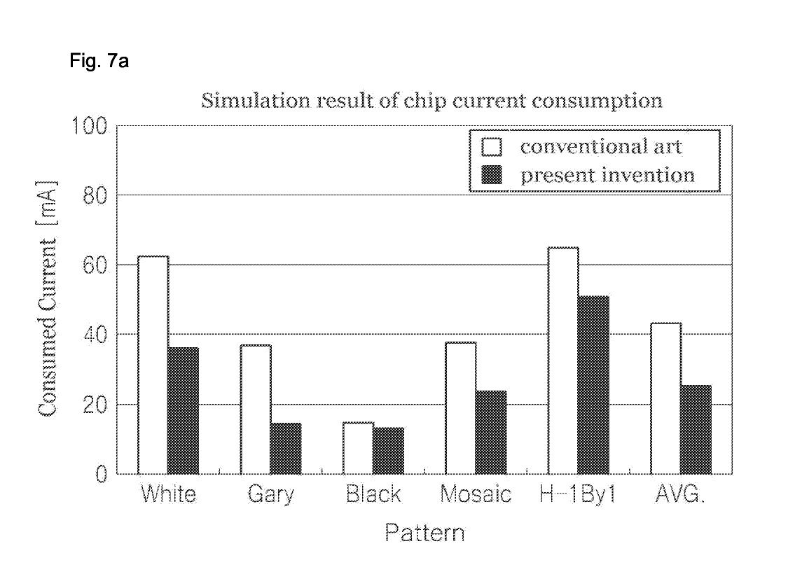

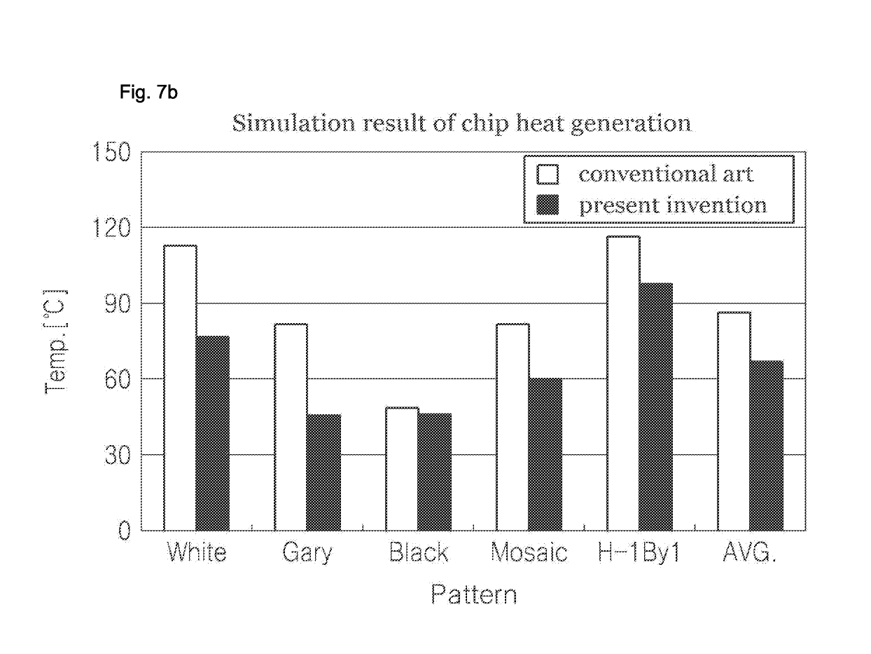

FIG. 7a is a graph illustrating a simulation result of current consumption of a conventional display driving circuit and the display driving circuit in FIG. 2.

Referring to FIG. 7a, in the graph illustrating the simulation result of current consumption, an X axis denotes test patterns of a pixel signal and a Y axis denotes current amounts (mA) consumed in the display driving circuits according to each test pattern.

In more detail, the X axis includes a white pattern that outputs a white stop screen, a gray pattern that outputs a gray stop screen, a black pattern that outputs a black stop screen, a mosaic pattern that outputs a stop screen with a chessboard pattern, a horizontal line (H-1By1) pattern that outputs a stop screen with a horizontal stripe by crossing a black color and a white color in each horizontal scan line, and a pattern average (AVG) indicating an average thereof.

A white bar graph indicates a current consumption amount of the conventional display driving circuit, and a black bar graph indicates a current consumption amount of the display driving circuit 200 according to an embodiment of the present invention.

In the case of the white pattern, a consumed current of the display driving circuit of the present invention is about 35 mA and is reduced by about 30 mA (46%) as compared with about 65 mA that is the conventional consumed current.

Particularly, in the case of the gray pattern in which a potential variation of an output voltage is small on the basis of a pre-charging voltage, a consumed current of the display driving circuit of the present invention is about 15 mA and is considerably reduced by about 20 mA (57%) as compared with about 35 mA that is the conventional consumed current.

Also in the other patterns, the display driving circuit has an effect that a consumed current is reduced by 3% (the black pattern) to 25% (the mosaic pattern) as compared with the conventional art.

In short, the average consumed current (AVG) of the display driving circuit is about 27 mA and is reduced by about mA (40%) as compared with about 43 mA that is the conventional average consumed current.

FIG. 7b is a graph illustrating a simulation result of heat generation of a conventional display driving circuit and the display driving circuit in FIG. 2.

Referring to FIG. 7b, in the graph illustrating the simulation result of heat generation, an X axis denotes test patterns of a pixel signal and a Y axis denotes temperature (° C.) measured in the display driving circuits according to each test pattern.

Similarly to FIG. 7a, in the case of the gray pattern, the temperature of the display driving circuit is about 45° C. and is reduced by about 33° C. (42%) as compared with about 78° C. that is the conventional temperature.

Also in the other patterns, the display driving circuit has an effect that the temperature is reduced by 3% (the black pattern) to 34% (the white pattern) as compared with the conventional art.

In short, the average temperature (AVG) of the display driving circuit is about 63° C. and is reduced by about 24° C. (28%) as compared with about 87° C. that is the conventional temperature.

In the present embodiments, each of the first and second pre-charging voltages PCP and PCN has been described to be one; however, the present invention is not limited thereto, and the first and second pre-charging voltages PCP and PCN may be expanded to two or more according to a product application example.

A display device includes a display panel and a display driving circuit that drives the display panel, wherein the display driving circuit includes an output buffer unit that is connected to a common voltage Vcom and first and second voltages VDD and VSS and buffers a pair of pixel signals; an output switch that directly connects the pair of buffered pixel signals to a pair of output lines or connects the pair of buffered pixel signals to the pair of output lines such that they cross each other; and a pre-charging unit that outputs the pair of buffered pixel signals by using pre-charging voltages connected between the first voltage VDD and the common voltage Vcom and between the second voltage VSS and the common voltage Vcom.

While various embodiments have been described above, it will be understood to those skilled in the art that the embodiments described are by way of example only. Accordingly, the disclosure described herein should not be limited based on the described embodiments.

What is claimed is:

1. A display driving circuit comprising:
an output buffer unit that outputs a pair of pixel signals by using a common voltage and first and second voltages;
an output switch that directly transfers the pair of pixel signals to a pair of output lines or transfers the pair of pixel signals to the pair of output lines such that the pair of pixel signals cross each other in correspondence with repetitive panel charging/discharging periods; and
a pre-charging unit that performs pre-charging for the pair of output lines in correspondence with a pre-charging period between the panel charging/discharging periods by using a first pre-charging voltage between the first voltage and the common voltage and a second pre-charging voltage between the second voltage and the common voltage.

2. The display driving circuit according to claim 1, wherein the output buffer unit comprises:
a first output buffer that outputs a first pixel signal with a first polarity between the first voltage and the common voltage by using the first voltage and the common voltage; and
a second output buffer that outputs a second pixel signal with a second polarity between the common voltage and the second voltage by using the common voltage and the second voltage,
wherein the first voltage is higher than the common voltage and the common voltage is higher than the second voltage.

3. The display driving circuit according to claim 1, wherein the output switch directly transfers the pair of pixel signals to the pair of output lines when the pair of pixel signals are not inverted and are output, and transfers the pair of pixel signals to the pair of output lines such that the pair of pixel signals cross each other when the pair of pixel signals are inverted and are output.

4. The display driving circuit according to claim 1, wherein the pre-charging unit comprises:
a first pre-charging switch that transfers the first pre-charging voltage to a first output line for non-inversion of the pair of pixel signals;
a second pre-charging switch that transfers the second pre-charging voltage to the first output line for inversion of the pair of pixel signals;
a third pre-charging switch that transfers the first pre-charging voltage to a second output line for the inversion of the pair of pixel signals; and
a fourth pre-charging switch that transfers the second pre-charging voltage to the second output line for the non-inversion of the pair of pixel signals.

5. The display driving circuit according to claim 1, wherein the pre-charging unit is configured to alternately provide the first pre-charging voltage and the second pre-charging voltage to the output lines different from each other in correspondence with a case in which the pair of pixel signals are not inverted and are output and a case in which the pair of pixel signals are inverted and are output.

6. The display driving circuit according to claim 1, wherein, when polarities of the pair of pixel signals output to the pair of output lines in a next panel charging period are maintained, the pre-charging unit performs the pre-charging by using the first and second pre-charging voltages equal to the pixel signals of the pair of output lines of a previous panel charging period, and
when the polarities of the pair of pixel signals output to the pair of output lines in the next panel charging period are inverted, the pre-charging unit performs the pre-charging by using the first and second pre-charging voltages different from the pixel signals of the pair of output lines of the previous panel charging period.

7. The display driving circuit according to claim 1, wherein the first pre-charging voltage is set as an intermediate voltage of the first voltage and the common voltage, and the second pre-charging voltage is set as an intermediate voltage of the common voltage and the second voltage.

8. The display driving circuit according to claim 1, further comprising:
a charge sharing switch that connects the pair of output lines to each other,
wherein the charge sharing switch operates in correspondence with the pre-charging period and shares charge of the pair of output lines.

9. The display driving circuit according to claim 8, wherein any one of the pre-charging unit and the charge sharing switch operates in correspondence with a specific pre-charging period.

10. The display driving circuit according to claim 9, wherein, when polarities of the pair of pixel signals output to the pair of output lines in a next panel charging period are maintained, the pre-charging unit operates, and
when the polarities of the pair of pixel signals output to the pair of output lines in the next panel charging period are inverted, the charge sharing switch operates.

11. A display device comprising:
a display panel; and
a display driving circuit that drives the display panel,
wherein the display driving circuit comprises:
an output switch that directly transfers a pair of pixel signals to a pair of output lines or transfers the pair of pixel signals to the pair of output lines such that the pair of pixel signals cross each other in correspondence with repetitive panel charging/discharging periods; and
a pre-charging unit that performs pre-charging for the pair of output lines in correspondence with a pre-charging period between the panel charging/discharging periods by using a first pre-charging voltage between a first voltage and a common voltage and a second pre-charging voltage between a second voltage and the common voltage.

12. A display driving circuit comprising:
an output switch that directly transfers a pair of pixel signals with a positive polarity and a negative polarity to a pair of output lines or transfers the pair of pixel signals to the pair of output lines such that the pair of pixel signals cross each other in correspondence with repetitive panel charging/discharging periods; and
a pre-charging unit that performs pre-charging for the pair of output lines in correspondence with a pre-charging period between the panel charging/discharging periods by using a first pre-charging voltage corresponding to the positive polarity and a second pre-charging voltage corresponding to negative polarity.

13. The display driving circuit according to claim 12, wherein the pre-charging unit is configured to alternately provide the first pre-charging voltage and the second pre-charging voltage to the output lines different from each other in correspondence with a case in which polarities of the pair of pixel signals are not inverted and are output from the pair of output lines and a case in which the polarities of the pair of pixel signals are inverted and are output from the pair of output lines.

14. The display driving circuit according to claim 12, wherein, when polarities of the pair of pixel signals output to the pair of output lines in a next panel charging period are maintained, the pre-charging unit performs the pre-charging by using the first and second pre-charging voltages with polarities equal to polarities of the pixel signals of the pair of output lines of a previous panel charging period, and
when the polarities of the pair of pixel signals output to the pair of output lines in the next panel charging period are inverted, the pre-charging unit performs the pre-charging by using the first and second pre-charging voltages with polarities different from the polarities of the pixel signals of the pair of output lines of the previous panel charging period.

15. The display driving circuit according to claim 12, wherein the first pre-charging voltage is set as an intermediate voltage of the first voltage and the common voltage for driving the pixel signal with the positive polarity, the second pre-charging voltage is set as an intermediate voltage of the common voltage and the second voltage for driving the pixel signal with the negative polarity, the common voltage has a level higher than a level of the second voltage, and the first voltage has a level higher than a level of the common voltage.

16. The display driving circuit according to claim 12, further comprising:
a charge sharing switch that connects the pair of output lines to each other,
wherein the charge sharing switch operates in correspondence with the pre-charging period and shares charge of the pair of output lines.

17. The display driving circuit according to claim 16, wherein any one of the pre-charging unit and the charge sharing switch operates in correspondence with a specific pre-charging period.

18. The display driving circuit according to claim 17, wherein, when polarities of the pair of pixel signals output to the pair of output lines in a next panel charging period are maintained, the pre-charging unit operates, and
when the polarities of the pair of pixel signals output to the pair of output lines in the next panel charging period are inverted, the charge sharing switch operates.
